(19) United States
(12) Patent Application Publication
(10) Pub. No.: US 2003/0074636 A1
(43) Pub. Date: Apr. 17, 2003

(54) Enabling easy generation of XML documents from XML specifications

(75) Inventor: Harish Manepalli, San Jose, CA (US)

Correspondence Address: LAW FIRM OF NAREN THAPPETA, 80 Feet Road, 9/D, 1ST Floor, Opp. Police Station, 8TH Block, Koramangala, Bangalore, 560 095, IN

(73) Assignee: EnSoftek, Inc., Beaverton, OR

(21) Appl. No.: 10/269,122

(22) Filed: Oct. 11, 2002

Related U.S. Application Data
(60) Provisional application No. 60/328,819, filed on Oct. 15, 2001.

(51) Int. Cl. G06F 15/00

(52) U.S. Cl. 715/513

(57) ABSTRACT

Generating graphical user interfaces (GUIs) from XML DTD files. A user selects the DTD file for which a GUI is to be generated. The DTD file is parsed to identify the different elements present in the DTD file. The identified elements are represented in the form of a binary tree-like data structure referred to as a DTD binary object. The DTD binary object can be used at run-time to quickly construct the GUI forms. The GUI forms contain several edit fields where the user can enter data. The DTD binary object extracts the data entered by the user and saves the GUI form in XML format.

### RELATED APPLICATION

The present application is related to and claims priority from pending U.S. provisional application Serial No. 60/328,819; Date Filed: Oct. 15, 2001; Entitled, “Enabling Easy Generation of XML Documents from XML Specifications”, naming as Inventor: Harish MANEPALLI, and is incorporated in its entirety herewith.

### BACKGROUND OF THE INVENTION

1. Field of the Invention

The present invention relates to extensible markup language (XML), and more specifically to a method and apparatus for enabling easy generation of XML documents from XML specifications.

2. Related Art

XML is often used to represent structured documents in the form of text. Structured documents contain content (“data”) and some indication (“tag”) of what role that content plays. For example, in a structured document representing a bill of lading, a tag may indicate that the following data represents a user name, and the data representing the name may follow the tag. The tag and user data together form an element (or a portion thereof) in the XML document.

In general, a structured document contains several elements, with each tag specifying the role of the related data. For further details on XML, the reader is referred to a book entitled, “Beginning XML”, ISBN Number: 1861003412, and available from Wrox Press, which is incorporated in its entirety herewith.

XML specifications are used for describing and constraining the content of XML documents. XML DTDs (Document Type Definition) and XML schemas are example implementations of XML specifications. For conciseness, XML DTDs and XML schemas are hereafter referred to as DTDs.

XML documents are often created using graphical user interface (GUI) forms, typically for ease of use. The GUI forms need to be designed to match the XML specifications. In a prior approach, the GUI forms are manually designed to match the XML specification. A user enters the information according to the interface provided by the GUI form.

One problem with manual design of GUI forms is that the design may consume unacceptably long time. In addition, manual designing may be prone to human errors, which is undesirable as the designed GUI form is often required to match the XML specifications.

Therefore, what is needed is a method and apparatus that allows quick and accurate generation of graphical user interfaces from XML specifications.

### SUMMARY OF THE INVENTION

The present invention allows the generation of graphical user interfaces (GUI) forms from XML DTDs. A user may merely need to specify a DTD of interest, and an embodiment of the present invention generates a GUI form from the specified DTD. Each GUI form contains edit fields (in which user enters data) and associated labels. The labels are generated based on the elements specified in the DTD.

The user may then enter data in the corresponding edit fields of the GUI forms. The data along with the XML tags are stored in an XML document, which can be stored and/or transmitted.

A feature of the present invention processes repeating elements in a DTD by providing an “add button” in the GUI forms such that the user may add an instance of the element by clicking on the element. Similarly, a “delete” button is provided for the user to delete instances.

Another feature of the present invention processes choice elements in a DTD by providing radio buttons such that the user may select only one choice among multiple choices that are presented in the GUI form. Yet another feature of the present invention processes optional elements. The user need not fill the edit field corresponding to optional elements.

One more feature of the present invention allows Automatic Insertion Points in documents to facilitate “location persistence”, which may be appreciated based on an understanding of the manner in which forms may be generated and used in web based environments.

In a Web-based (e.g., HTML) form, the GUI is often regenerated on the server-side. In other words, the server-side software processes the user actions and regenerates the form. For a GUI form that is loaded again, the “insertion point” is highlighted, which allows the user to return to the same location, and the corresponding feature is referred to as “location persistence”.

In addition, the data entered by a user can be automatically checked for XML conformance based on DTD/Schema. Furthermore, the GUI forms may be generated to include a recursive DTD element definition. Yet another feature of the present invention enables a user to edit a previously generated XML document using a previously generated GUI form.

Further features and advantages of the invention, as well as the structure and operation of various embodiments of the invention, are described in detail below with reference to the accompanying drawings. In the drawings, like reference numbers generally indicate identical, functionally similar, and/or structurally similar elements. The drawing in which an element first appears is indicated by the leftmost digit(s) in the corresponding reference number.

### BRIEF DESCRIPTION OF THE DRAWINGS

The present invention will be described with reference to the accompanying drawings, wherein:

FIG. 1 is a block diagram illustrating an example environment in which the present invention can be implemented;

FIG. 2 is a block diagram illustrating the generation of a graphical user interface (GUI) from a XML specification (DTD);

FIG. 3 is an example GUI illustrating the manner in which a user may select a DTD from various DTDs;

FIGS. 4A-4I together contain a sample DTD selected by the user;

FIG. 5 is an example GUI corresponding to the sample DTD selected by the user; and

FIGS. 6A-6G together represent an XML document corresponding to the GUI of FIG. 5 and the DTD of FIGS. 4A-4I.

### DETAILED DESCRIPTION OF THE PREFERRED EMBODIMENTS

1. Overview and Discussion of the Invention

The present invention enables the generation of graphical user interface (GUI) forms from an XML specification such as a DTD (document type definition). The GUI forms match (correspond to) the XML specification present in the DTD. The GUI may be generated from any DTD, thus making it possible for software systems to generate many XML documents. The GUI form can then be used by a user to enter data (user input/data) into the form, and an XML document is generated corresponding to the DTD and the user input.

Several aspects of the invention are described below with reference to example environments for illustration. It should be understood that numerous specific details, relationships, and methods are set forth to provide a full understanding of the invention. One skilled in the relevant art, however, will readily recognize that the invention can be practiced without one or more of the specific details, or with other methods, etc. In other instances, well-known structures or operations are not shown in detail to avoid obscuring the invention.

2. Example Environment

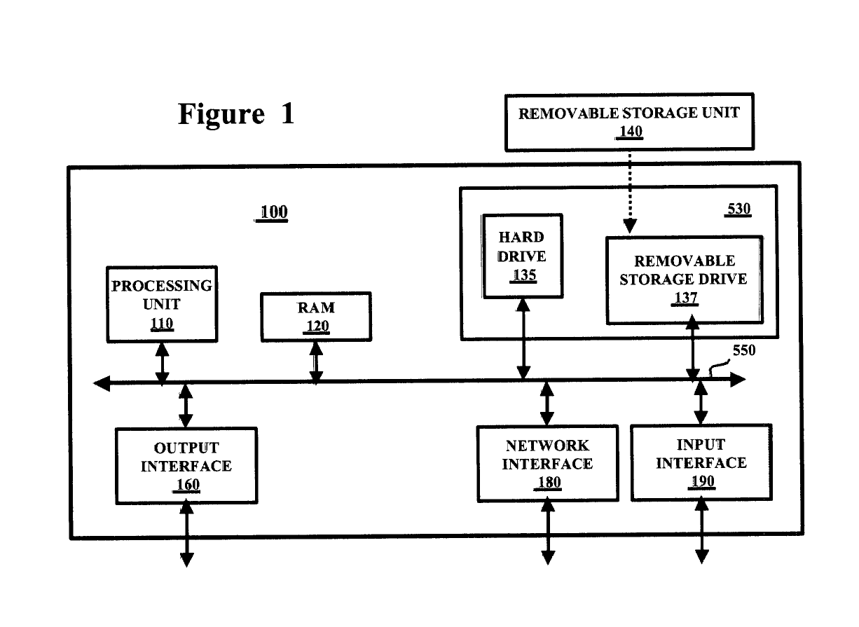

FIG. 1 is a block diagram illustrating the details of computer system 100 in one embodiment. Computer system 100 is shown containing processing unit 110, random access memory (RAM) 120, storage 130, output interface 160, network interface 180 and input interface 190. Each component is described in further detail below.

Output interface 160 provides output signals (e.g., display signals to a display unit, not shown) that can form the basis for a suitable user interface for a user to interact with computer system 100. Input interface 190 (e.g., interface with a key-board and/or mouse, not shown) enables a user to provide any necessary inputs to computer system 100. Output interface 160 and input interface 190 can be used, for example, to enable a user to interface with computer system 100 while selecting DTDs, and to generate XML documents using the UI generated according to an aspect of the present invention.

Network interface 180 enables computer system 100 to send and receive data on communication networks using protocols such as Internet Protocol (IP). Network interface 180 may enable multiple units of computer systems to be networked to cooperatively implement various features of the present invention. Such cooperating multiple units may also be conveniently referred to as a computer system. Network interface 180, output interface 160 and input interface 190 can be implemented in a known way.

Processing unit 110 may contain one or more processors. Some of the processors can be general purpose processors which execute instructions provided from RAM 120. Some can be special purpose processors adapted for specific tasks. The special purpose processors may also be provided instructions from RAM 120. In general, processing unit 110 reads sequences of instructions from various types of memory medium (including RAM 120, storage 130 and removable storage unit 140), and executes the instructions to provide various features of the present invention described above.

RAM 120 and/or storage 130 may be referred to as a memory. RAM 120 may receive instructions and data on path 150 from storage 130. Even though shown as one unit, RAM 120 may be implemented as several units. Secondary memory 130 may contain units such as hard drive 135 and removable storage drive 137. Secondary memory 130 may store the software instructions and data, which enable computer system 100 to provide several features in accordance with the present invention.

Some or all of the data and instructions (software routines) may be provided on removable storage unit 140, and the data and instructions may be read and provided by removable storage drive 137 to processing unit 110. Floppy drive, magnetic tape drive, CD-ROM drive, DVD Drive, Flash memory, removable memory chip (PCMCIA Card, EPROM) are examples of such removable storage drive 137.

In this document, the term “computer program product” is used to generally refer to removable storage unit 140 or hard disk installed in hard drive 135. These computer program products are means for providing software to computer system 100. As noted above, CPU 110 may retrieve the software instructions, and execute the instructions to provide various features of the present invention.

The logic underlying the implementation of software instructions will be clear from the description of various features of the present invention. A broad overview is provided first, and the features are described below in further detail.

3. Broad Overview

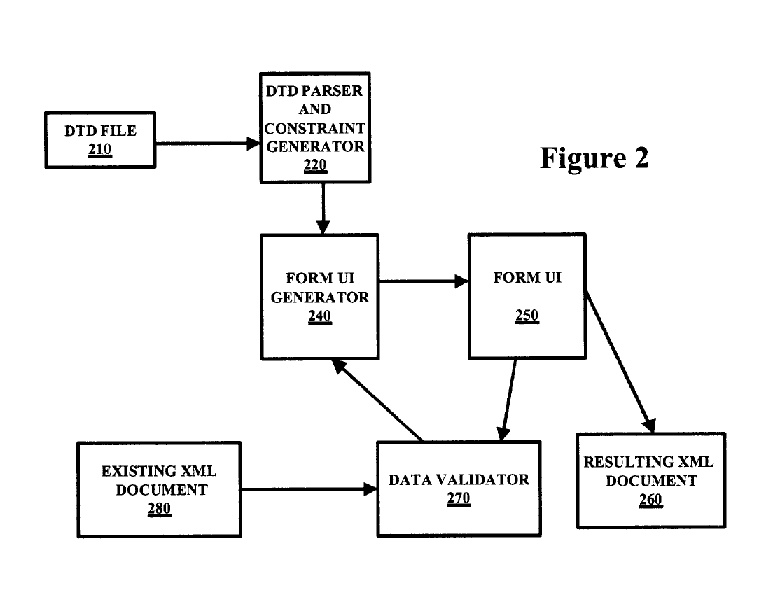

FIG. 2 is a block diagram providing a broad overview of various aspects of the present invention. FIG. 2 is shown containing DTD file block 210, DTD parser and constraint generator 220, form UI generator 240, form UI 250, data validator 270 and XML documents 260 and 280. Each block is described below in further detail.

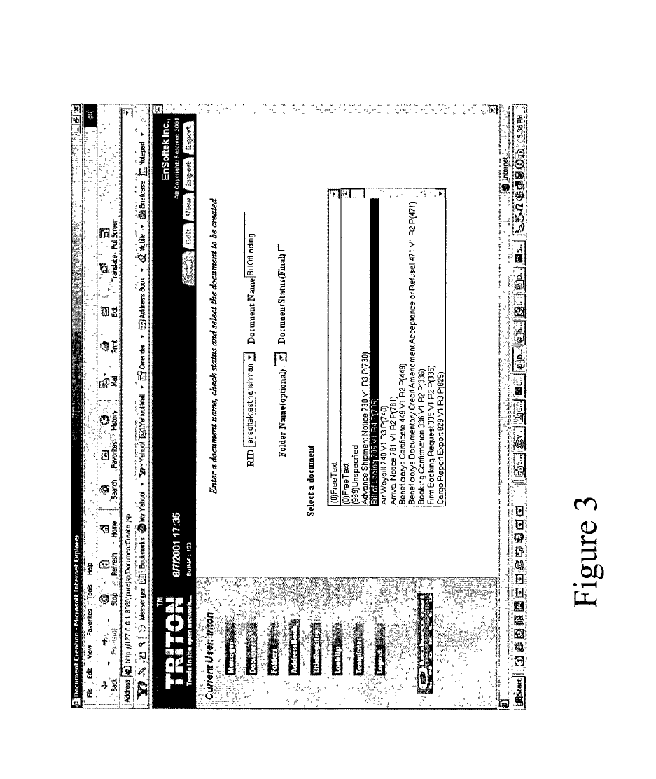

DTD file block 210 contains a list of various DTDs from which GUI forms can be generated. For creating a GUI, the user may merely need to select a DTD file from DTD file block 210. As described earlier, a DTD file generally contains multiple elements and associated organization. The manner in which the user may select a DTD file from DTD file block 210 is illustrated in a section below with reference to FIG. 3.

DTD parser and constraint generator 220 parses (examines) a selected DTD to ensure that the DTD content is consistent with the XML specification rules. DTD parser and constraint generator 220 may then store any necessary information in a format suitable for quick retrieval when generating GUI forms (potentially both while generating and editing XML documents). In an embodiment described in sections below, DTD parser and constraint generator 220 stores the information in a memory in the form of a DTD binary object.

Form UI generator 240 generates form UI 250 based on the DTD binary object stored in the memory as noted above. The various attributes associated with each element in the DTD are used to determine the content of each displayed screen. While generating form UI 250, variable names are assigned to the various elements that are required to be displayed. The variable names enable a user to understand the nature of information presented and the corresponding data to be entered.

Data validator 270 validates any entered data consistent with various requirements such as data type, permissible range, etc. The loop of form UI 250, data validator 270 and form UI generator 240 represents the situation in which a user enters data, and form UI generator 240 re-generates form UI 250 representing the entered data. For example, if a user deletes an instance of a repeating element, form UI 250 is re-generated with the instance deleted.

Once the user indicates completion of entry of data (for example, by clicking on a ‘save’ button), an XML document (“resulting XML document 260”) is generated. The DTD binary object is used to determine the various elements with which each entered data item is to be associated. In general, the software instructions need to ‘keep track of’, the co-relation between the elements specified by a DTD and the displayed fields, and generates the XML documents.

Thus, an aspect of the present invention enables a XML documents to be generated based on a provided DTD. Another aspect of the present invention enables existing XML documents also to be edited as described below.

Existing XML document 280 can be provided as an input to computer system 100. The DTD binary object generated by DTD parser and constraint generator 220 may be used by form UI generator 240 and data validator 270 to ensure that the data present in existing XML document 280 is consistent with the DTD specification and the data types.

Form UI 250 is again generated based on the DTD binary object and the validated data. The user can again edit the document, and the modified XML documents can again be stored (as resulting XML document 260) for subsequent use (storing, transmission, etc.).

Thus, the present invention enables GUI forms (Forms UI) to be conveniently generated based on XML specification. The description is continued with reference to several of the blocks described above.

4. Selection of a DTD

FIG. 3 is shown containing a screen in which a user is instructed to select the document to be created, enter the document's name and check status. In the field entitled “select a document”, the user chooses among various DTD files (for example, advance shipment notice 730 V1 R3 P (730), bill of lading, etc.). The user is shown selecting the “bill of lading” DTD for illustration.

In the field entitled “document name”, the user enters the name to be associated with the instance of the GUI form to be generated from the selected DTD. A system in accordance with the present invention may generate GUI forms and XML documents while reducing human intervention. The generation generally entails understanding the general format of XML specification. Accordingly, an example DTD is described below in greater detail.

5. Contents of DTD

Various types of elements may be present in a DTD. Each type of element generally needs to be processed consistent with its intended utility. In an embodiment, DTD elements include repeating elements, optional elements, choice elements and mandatory elements. Each element is described below in further detail.

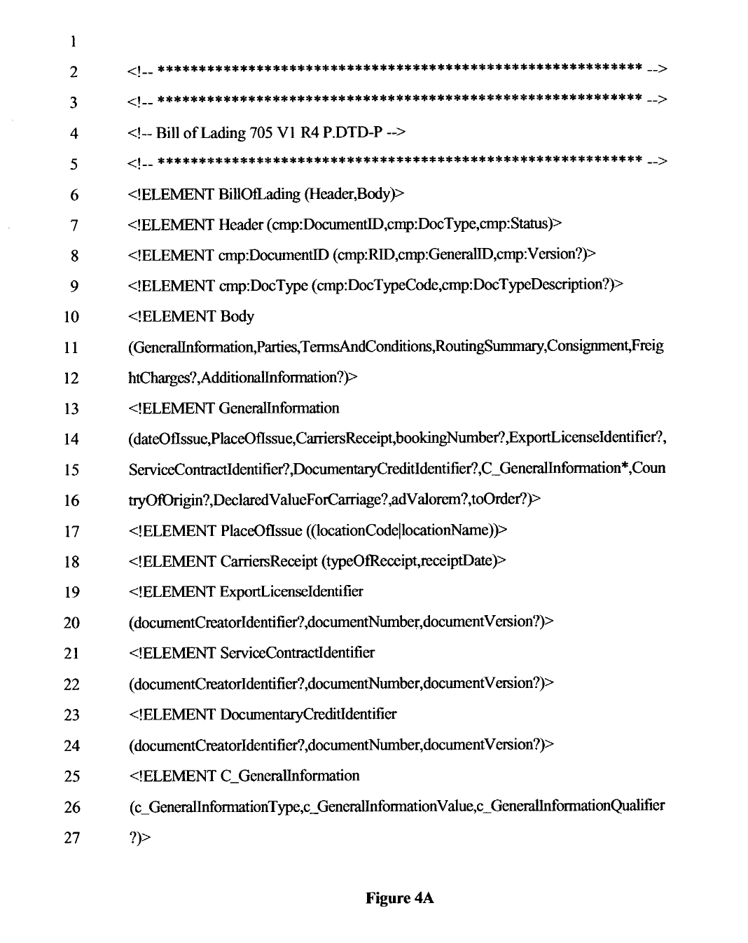

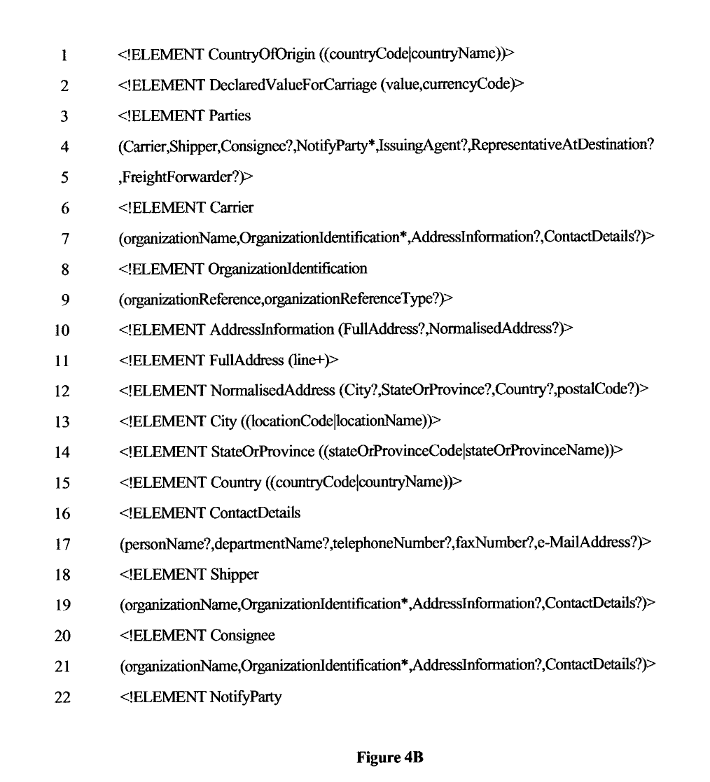

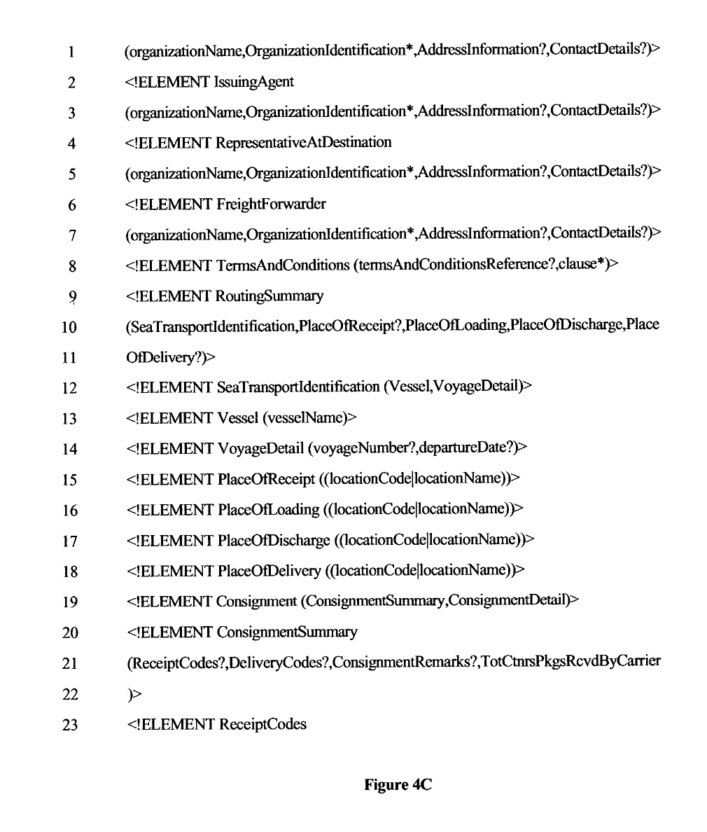

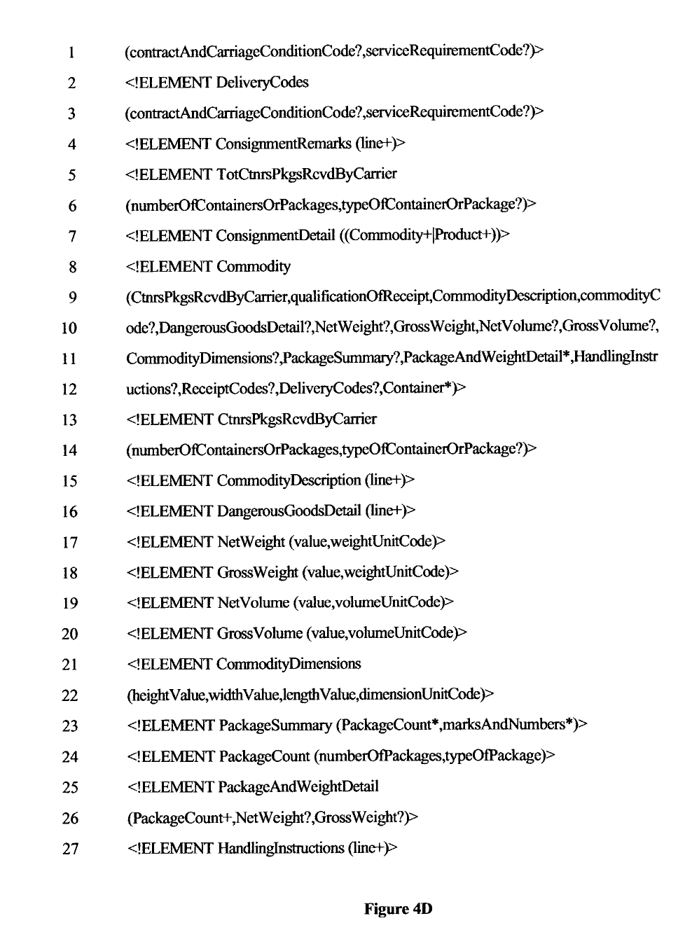

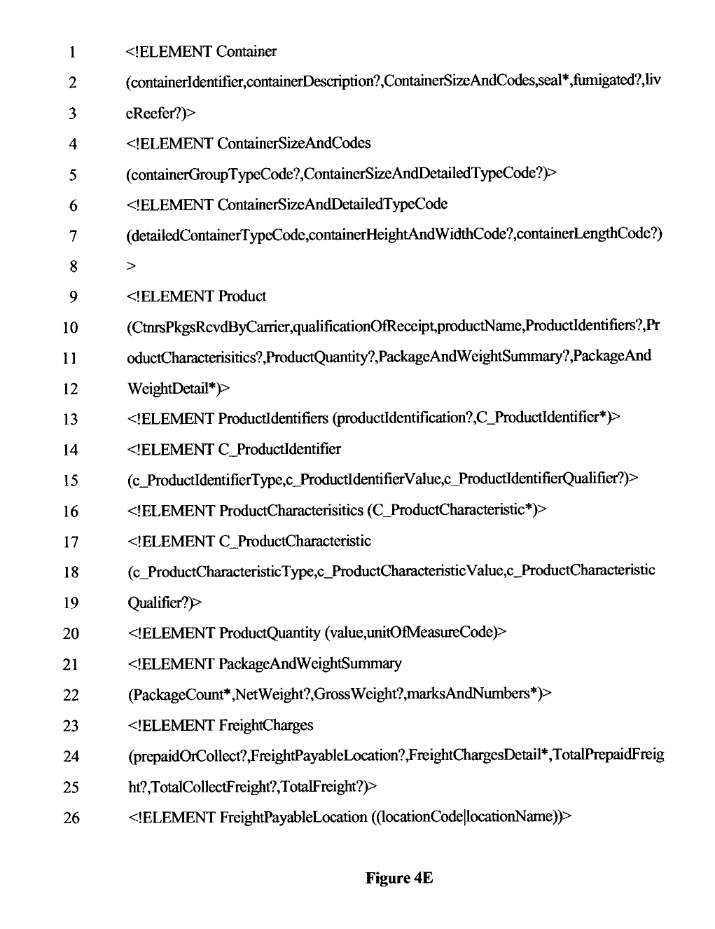

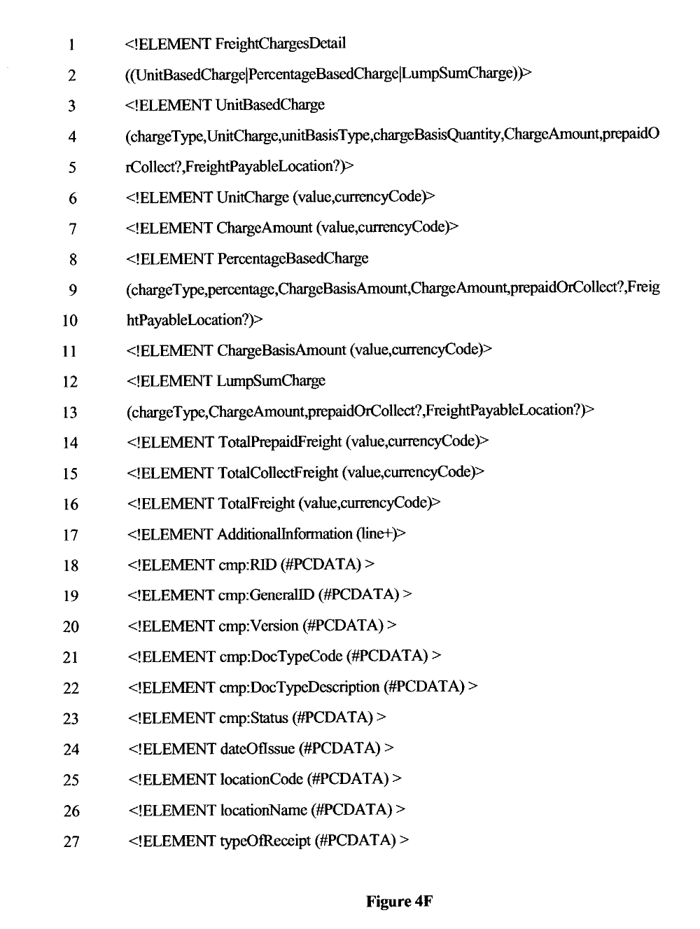

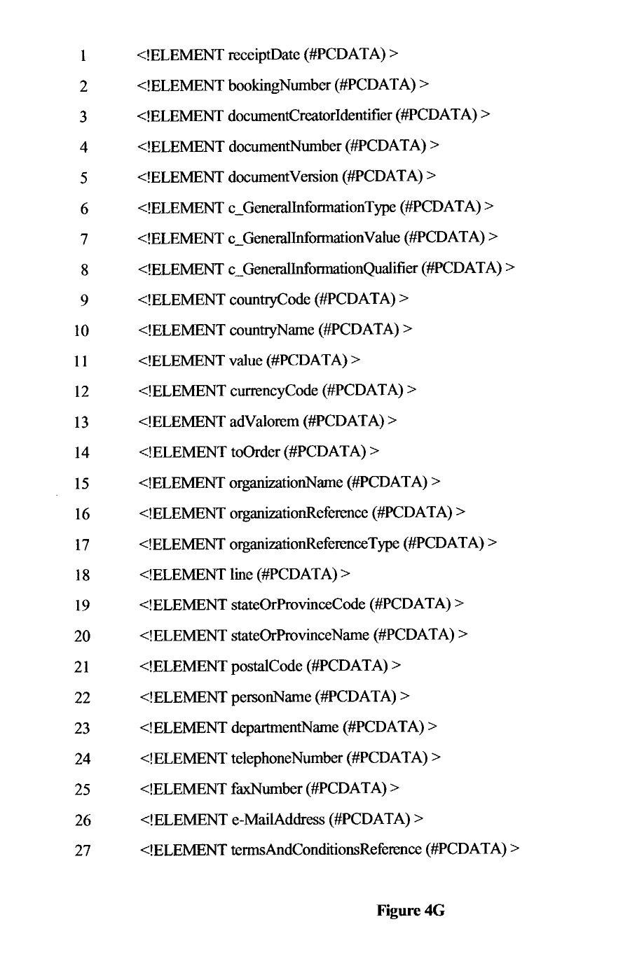

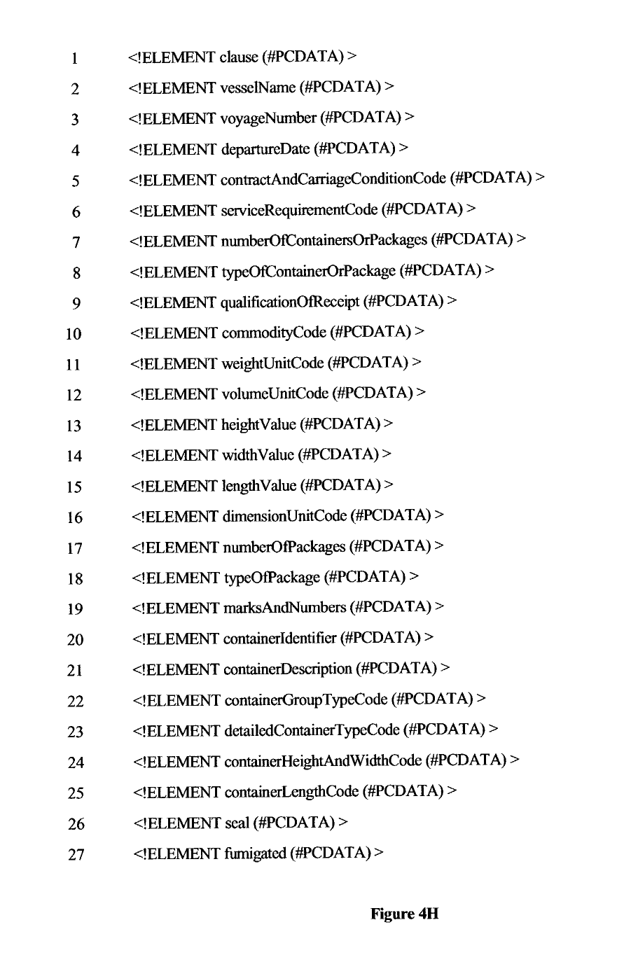

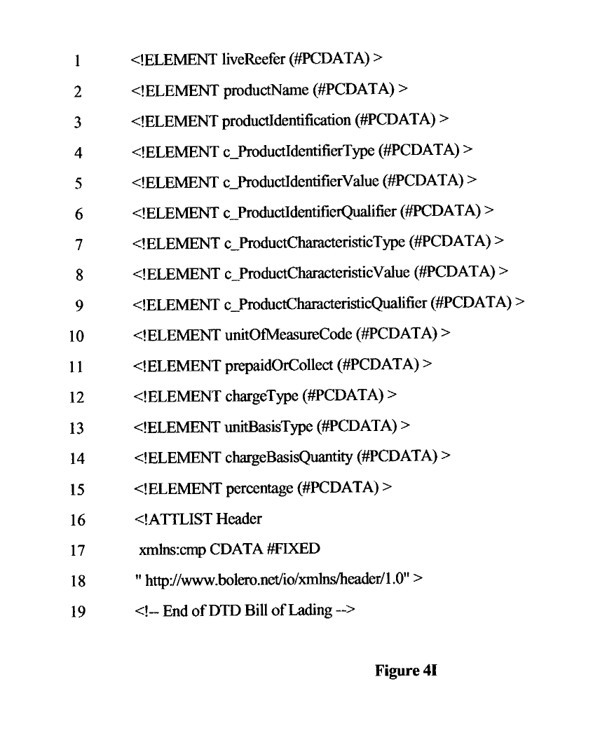

Repeating elements are those that are generally repeated. In the XML specification, repeating elements are generally followed by a “*” or a “+” (according to DTD convention). For example, in line numbers 12 of FIG. 4B, the element “full address” is followed by a “+” indicating that the element is a repeating element.

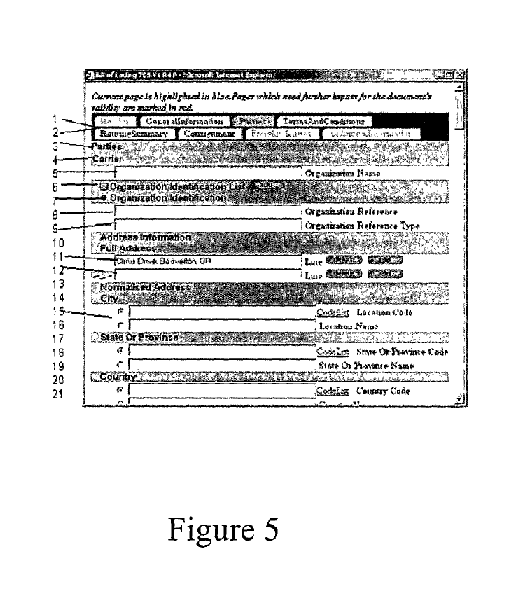

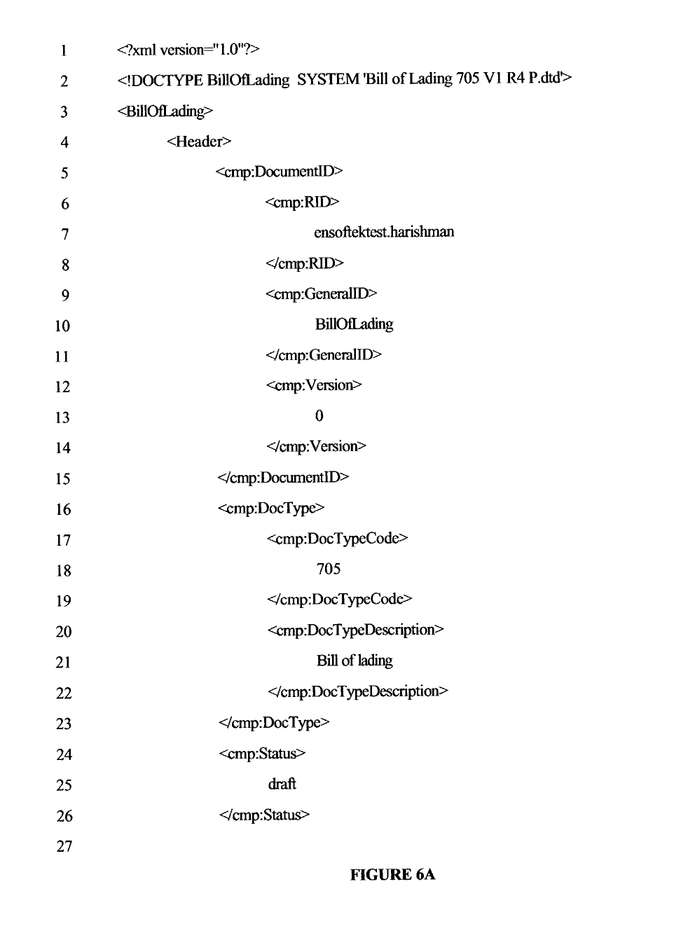

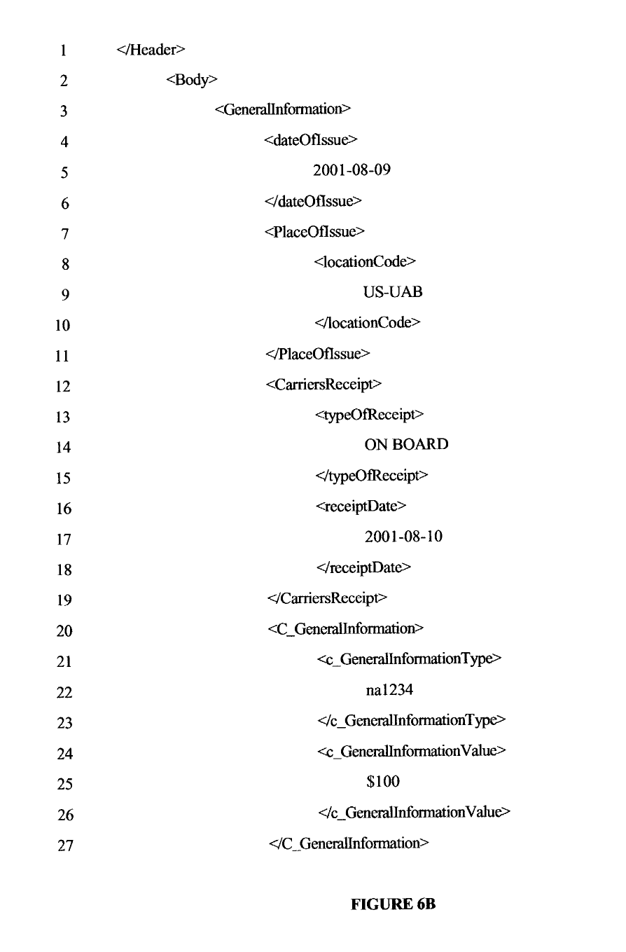

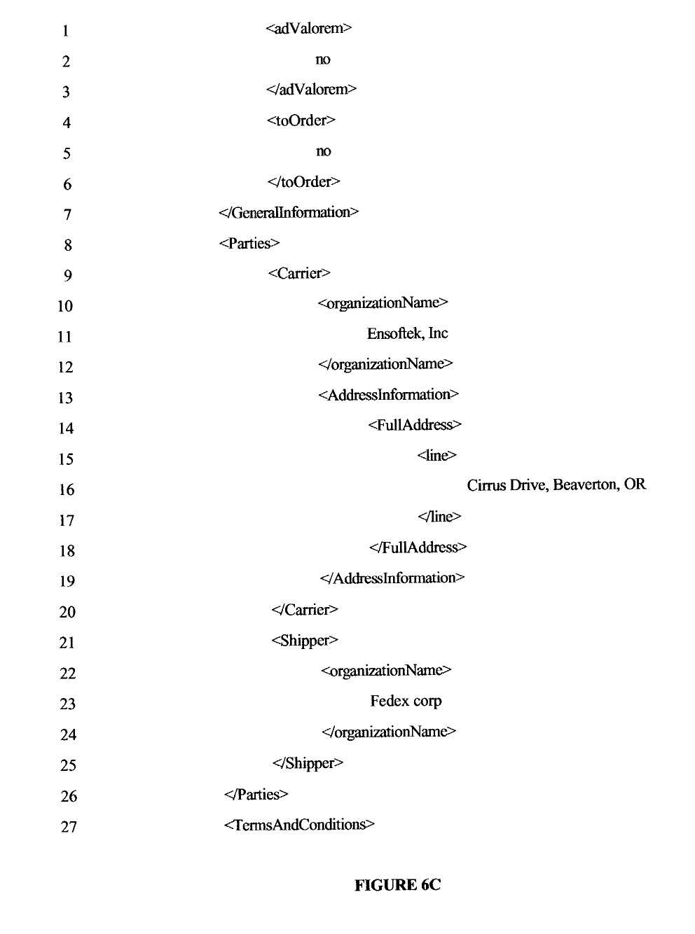

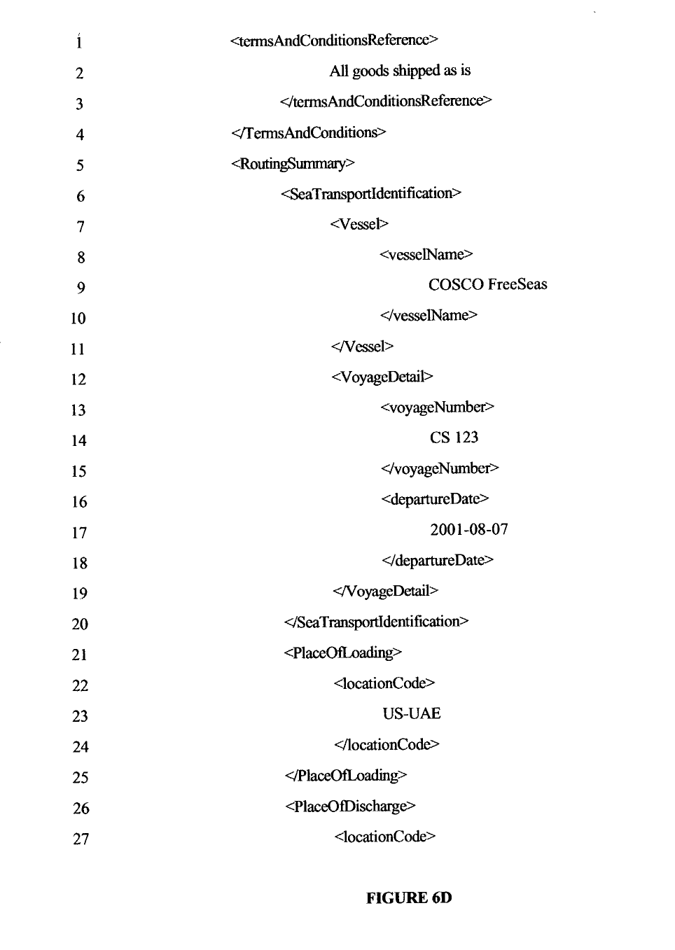

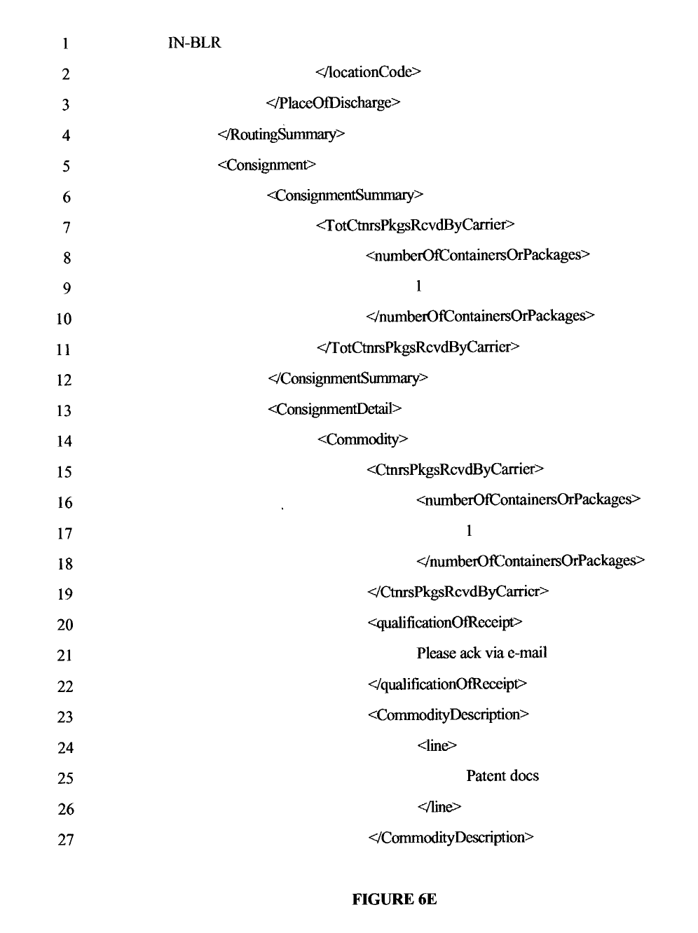

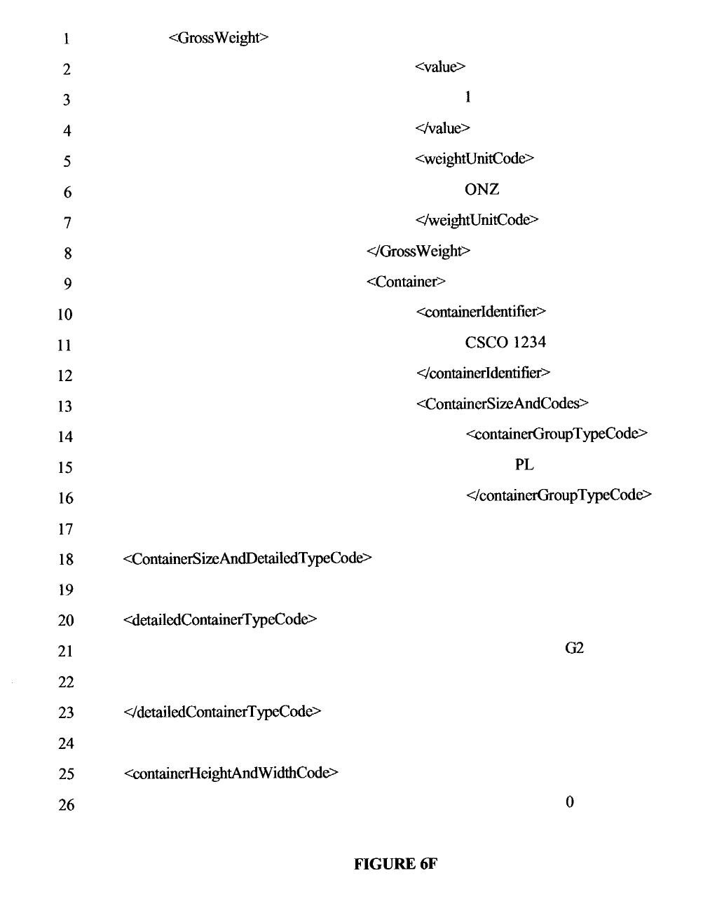

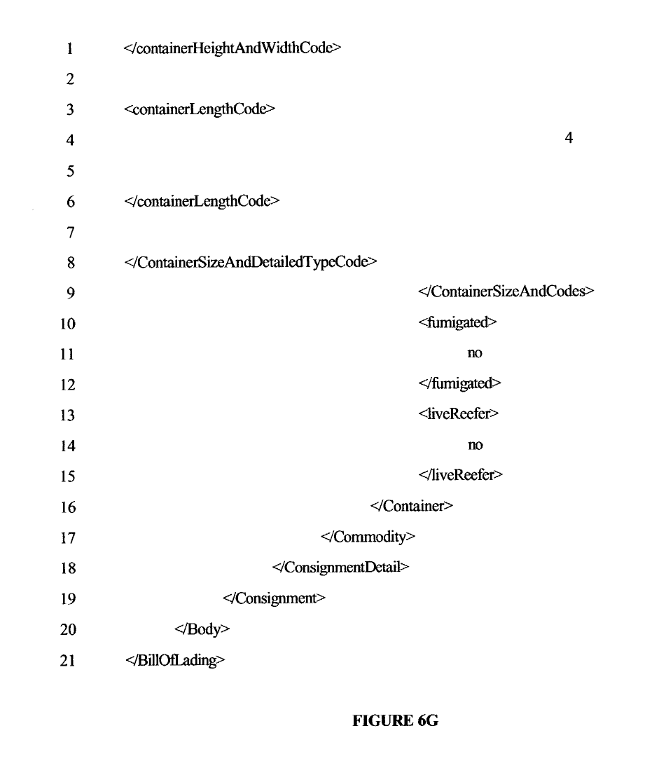

For repeating elements an “add” button is provided such that the user can add another instance of the element by clicking on the add button (line number 6 of FIG. 5). For a newly added element, the UI form automatically generates an “insertion point bookmark” that a web-browser could scroll to, this gives “location persistence”.

In addition, a “delete button” may be provided to delete an instance of the repeating element (line number 11 of FIG. 5). If only once instance is present, delete button may not be provided. In the case of non repeating elements, the “add” and “delete” buttons are not be provided.

Optional elements generally have a “?” next to it. For example, in line number 14 of FIG. 4B, “city”, “state or province”, “country” and “postal code” respectively have a “?” at the end thus making the four elements optional. All non optional elements are considered mandatory and are known as mandatory elements. Mandatory elements are generally marked in a different color, for example, red.

Leaf node corresponds to a node in the DTD hierarchy that does not have children (line 5 of FIG. 2). XML allows these nodes to have values. At a given level, the DTD may require only one of many nodes. Such nodes are referred to as choice nodes. Choice nodes may be represented by inserting a “|” between each node. For example, in line number 15 of FIG. 4B the node “city” contains nodes “location code” and “location name” separated by a “|”.

As noted above, for speed of generating GUI forms, a DTD binary object may be generated. The manner in which an example implementation of DTD parser and constraint generator 220 may generate the binary object is described below.

6. DTD parser and constraint generator 220

DTD parser and constraint generator 220 identifies if an element in the selected DTD is a leaf or a non-leaf node, identifies the element's cardinality (whether the element is repeating, mandatory, etc), identifies the element's parent and identifies the element's children. The properties associates with each element and the relationships between elements (e.g., one element being a part of another element) are determined.

In an embodiment, all the determined information is represented in the form of a binary tree-like data structure, and may be referred to as a DTD binary object. DTD binary object contains a root node which may have children. Each node may have the following properties.

A boolean leaf value may be present for each node which when true indicate that the corresponding node is a leaf node. A boolean mandatory value may be present for each element, which when true indicate that the at least one instance of the corresponding element is required. Similarly, a boolean value for repeating element which when true indicate that the corresponding elements allows more than one instance to added. Each node may have one link to the parent node and zero or more links to the child nodes.

The DTD binary object may contain the bit representation of the DTD. Since the DTD is usually described in text format, accessing the various elements in text-representation may not be very efficient. An internal representation is generally used which allows access to the various elements quickly. The DTD binary object may be referred to as a tree like structure as the information in the DTD binary object is structured hierarchically (for example, a node has 0 or more children, a node has only one parent).

DTD binary object may be used at run-time to construct the GUI forms, which can be used both for generating new XML documents and for editing prior-generated documents. The DTD binary objects maybe included in the installation bundles provided to the users. The DTD binary object may be stored and provided in a memory (of FIG. 1).

Based on the DTD binary object, GUI screens may be generated by software instructions provided in accordance with the present invention. The manner in which GUI screens relate to the GUI forms is described below with an example.

7. Structure of User Interface

While generating UI form 250, form UI generator 240 follows a structure. The DTD file is laid out hierarchically, describing elements at every level. The elements contained within each level are referred to as children.

In general, all top level children get a separate UI page each. For example, the top level children corresponding to line numbers 10-12 of FIG. 4A namely, general information, parties, terms and conditions, routing summary, consignment, freight charges, additional information respectively get a separate UI. In FIG. 5, top level element “parties” (shown in line numbers 1 and 2) is shown in a single page.

With respect to non leaf elements, the element name is drawn in a special background color. For example, non leaf elements corresponding to line numbers 3-6 in FIG. 4B are shown as elements with labels “parties” and “carrier”. The elements are drawn in a special background color as shown in line numbers 3-4 of FIG. 5.

Leaf nodes in the DTD hierarchy generally have a field in which data can be entered by the user. For a leaf node that requires the user to enter data, a text label may be added with the leaf node's descriptive name along with a data input field in which the user may enter data (can be text box or drop down list). For example, the leaf node corresponding to line 5 of FIG. 5 requires the user to enter data. A text label “organization name” is added as the leaf node's descriptive name along with a data input field in which the user enters data (can be text box or drop down list).

On the other hand, when the leaf node is a choice node, i.e., when the user has to select a choice among multiple choices, the choices (“siblings”) may be put into a radio-group and a radio button is placed next to the corresponding leaf node. This enables the user to select only one sibling. If the selected sibling is a leaf element, a data input field may also be added as described above.

For example, choice nodes are shown in line numbers 15 and 16 of FIG. 5. Choice elements corresponds to line 15 in FIG. 4B. The user has to select a choice between “location code” of the city or the “location name” of the city. The ‘location code’ of the city has a data input field where the user selects from a list of codes and the ‘location name’ of the city is a leaf element having a data input field where the user enters the name of the city.

With respect to repeating elements (both * and +) having no instance data, one instance may be laid out on the UI form and an “add” button is placed next to the element. For repeating elements with instance data (more than one instance of it), all the elements may be laid out using the above rules, and a “delete button” also is placed next to each element.

For example, repeating element “organization identification” corresponding to line 7 of FIG. 4B may be laid out in form UI 250 as shown in line 6 of FIG. 5. The label “organization identification list” and an “add” button is placed next to it. For repeating elements “full address” (corresponding to line number 12 of FIG. 4B) with instance data as shown in line numbers 11-12, a “delete button” is placed next it.

Thus, a DTD needs to be parsed to determine the various elements presents in the DTD and the manner in which GUI needs to be generated. As may be appreciated, it is generally helpful to provide labels (names) associated with the displayed fields. An example convention that may be employed in naming various fields is described below. 1

8. Field Naming

Form UI 250 may be generated by form UI generator 240 as described above. Form UI 250 may contain several fields and/or buttons. The user is required to enter data in specific fields and also select appropriate choices. On completing the requirements specified in form UI 250, the user may submit form UI 250 for processing. In an embodiment, the following notation is used to name variables. Edit fields are presented for leaf elements only. Starting from the root node of the DTD, a string containing the node name and the index of the parent is used. For example, “RootNode.0.Child.1.Data.2” refers to the third instance of data in the second instance of child node under the first instance of the root node. Similarly, for add and delete buttons, a prefix of “action” (for add) and “delete” is used to denote the selected action. In the case of choice elements, the prefix of “choice” is used to denote the choice action selected.

Form UI generator 240 may validate form UI 250 by using the following set of rules:

1. The fields corresponding to mandatory elements is non empty;

2. Mandatory elements which are within optional elements are considered optional;

3. If an optional element within an optional element is filled, then all mandatory elements within the respective optional field becomes mandatory;

4. Optional fields may be empty; and

5. External field type specific data validation is used to conform specifications that are external to the DTD. The conformance can be attained as described below.

As is well known in the relevant arts, the DTD generally only specifies how the elements are structured in the document, and rules on which elements can occur at a particular location (whether it is optional or repeating). However, DTD makes no mention about the “allowed values” for a given element. XML designers could specify these “allowed values” in a separate document (“field type specifications”). The data validation software can use such external field type specifications to ensure “data conformance” as well.

After validating form UI 250 based on the set of rules described above, form UI 250 may be saved in XML format. The manner in which form UI 250 may be saved as an XML document is described below.

9. Saving in XML Format

Form UI generator 240 may extract the data from form UI 250 which is submitted by the user and saves form UI 250 in XML format. While saving in XML format, form UI generator 240 extracts the field names and data from form UI 250 and inserts the data into the appropriate locations in the XML document. Depending on whether the user added or deleted data, the data is added or deleted from the corresponding locations of the XML document. Similarly, where the user selects among multiple choices, form UI generator 240 tracks data belonging to the selected element and saves data for the selected element.

FIGS. 8A through 8G together represent XML document 260 which is the XML version of form UI 250. XML document 260 contains the information that the user enters in all the edit fields that are present in form UI 260.

For example, assume the user enters “EnSoftek, Inc” in the edit field entitled “RID” present next to the “organization name” text label as shown in line number 5 of FIG. 5. The information is saved in XML format as shown in line number 11 of FIG. 8C.

Similarly, the information entered by the user in the edit field corresponding to “full address” shown in line number 11 of FIG. 5 is saved in XML format as shown in line number 16 of FIG. 8C.

Thus, a graphical user interface may be generated from a DTD document selected by a user. The information entered by the user in the respective fields of the GUI form may be saved in XML format as described above. Accordingly, the present invention simplifies the generation of XML documents from the DTD documents.

10. Conclusion

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

What is claimed is:

1. A method of creating XML documents, said method comprising:
parsing using a computer system a Document Type Definition (DTD) to determine a plurality of elements comprised in said DTD;
providing in said computer system a graphical user interface (GUI) which enables a user to enter a plurality of data elements associated with said plurality of elements; and
generating in said computer system an XML document according to said DTD and said plurality of data elements.

2. The method of claim 1, wherein said generating comprises creating an intermediate form representing a parent-child relationship between each of said plurality of elements, wherein said GUI is generated by examining said intermediate form.

3. The method of claim 2, wherein said DTD specifies a cardinality of each of said plurality of elements, wherein said creating includes data representing said cardinality in said intermediate form, and said generating generates said GUI according to said cardinality.

4. The method of claim 3, wherein said cardinality indicates whether a first element comprised in said plurality of elements is a repeating element, wherein said providing includes an add button and a delete button associated with said first element, wherein said add button enables said user to an instance of said first element in said GUI and said delete button enables said user to delete said instance of said first element in said GUI.

5. The method of claim 3, wherein said cardinality indicates whether a second element comprised in said plurality of elements is a mandatory element, an optional element or a choice element.

6. The method of claim 3, wherein said parsing indicates whether a third element comprised in said plurality of elements is a leaf node not having any children, wherein said includes an edit field associated with said third element if said third element is a leaf node.

7. The method of claim 6, wherein said providing displays a string associated with said edit field, wherein said string is formed by concatenation of names of nodes in the path from a root to said third element, wherein said names are contained in said DTD.

8. The method of claim 3, wherein said intermediate form comprises a binary object.

9. A computer readable medium carrying one or more sequences of instructions for causing a computer system to create XML documents, wherein execution of said one or more sequences of instructions by one or more processors contained in said system causes said one or more processors to perform the actions of:
parsing a Document Type Definition (DTD) to determine a plurality of elements comprised in said DTD;
providing a graphical user interface (GUI) which enables a user to enter a plurality of data elements associated with said plurality of elements; and
generating an XML document according to said DTD and said plurality of data elements.

10. The computer readable medium of claim 9, wherein said generating comprises creating an intermediate form representing a parent-child relationship between each of said plurality of elements, wherein said GUI is generated by examining said intermediate form.

11. The computer readable medium of claim 10, wherein said DTD specifies a cardinality of each of said plurality of elements, wherein said creating includes data representing said cardinality in said intermediate form, and said generating generates said GUI according to said cardinality.

12. The computer readable medium of claim 11, wherein said cardinality indicates whether a first element comprised in said plurality of elements is a repeating element, wherein said providing includes an add button and a delete button associated with said first element, wherein said add button enables said user to an instance of said first element in said GUI and said delete button enables said user to delete said instance of said first element in said GUI.

13. The computer readable medium of claim 11, wherein said cardinality indicates whether a second element comprised in said plurality of elements is a mandatory element, an optional element or a choice element.

14. The computer readable medium of claim 11, wherein said parsing indicates whether a third element comprised in said plurality of elements is a leaf node not having any children, wherein said includes an edit field associated with said third element if said third element is a leaf node.

15. The computer readable medium of claim 14, wherein said providing displays a string associated with said edit field, wherein said string is formed by concatenation of names of nodes in the path from a root to said third element, wherein said names are contained in said DTD.

16. The computer readable medium of claim 11, wherein said intermediate form comprises a binary object.

17. The computer readable medium of claim 11, further comprising enabling said user to edit an existing XML document formed according to said DTD, wherein said intermediate form is used to enable said user to edit said existing XML document.

18. A computer system for creating XML documents, said computer system comprising:
means for parsing using a Document Type Definition (DTD) to determine a plurality of elements comprised in said DTD;
means for providing a graphical user interface (GUI) which enables a user to enter a plurality of data elements associated with said plurality of elements; and
means for generating an XML document according to said DTD and said plurality of data elements.

19. The computer system of claim 18, wherein said means for generating creates an intermediate form representing a parent-child relationship between each of said plurality of elements, wherein said GUI is generated by examining said intermediate form.

20. The computer system of claim 19, wherein said DTD specifies a cardinality of each of said plurality of elements, wherein said creating includes data representing said cardinality in said intermediate form, and said generating generates said GUI according to said cardinality.
